(19) United States
(12) Patent Application Publication
(10) Pub. No.: US 2025/0140868 A1
(43) Pub. Date: May 1, 2025

(54) CURRENT COLLECTOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Da Young KANG, Suwon-si (KR); Su Hyun KIM, Suwon-si (KR); Kyu Seo LEE, Suwon-si (KR); Jung Wook CHA, Suwon-si (KR); Jung Min LEE, Suwon-si (KR); Jung Hyun NAM, Suwon-si (KR)

(21) Appl. No.: 18/930,860

(22) Filed: Oct. 29, 2024

(30) Foreign Application Priority Data
Nov. 1, 2023 (KR) 10-2023-0148972

(51) Int. Cl. H01M 4/66; H01M 4/02; H01M 10/0525

(52) U.S. Cl. CPC H01M 4/667; H01M 4/661; H01M 4/663; H01M 4/668; H01M 10/0525; H01M 2004/021

(57) ABSTRACT

A current collector for rechargeable lithium batteries and a rechargeable lithium battery including the same are disclosed. The current collector includes: a polymer support layer; a conductive layer on at least one surface of the polymer support layer; and a carbon-containing layer on at least one surface of the polymer support layer, and the carbon-containing layer includes at least one of carbon nanotubes or carbon nanofibers extending from the polymer support layer or the conductive layer.

### CROSS-REFERENCE TO RELATED APPLICATION

The present application claims priority to and the benefit of Korean Patent Application No. 10-2023-0148972, filed on Nov. 1, 2023 in the Korean Intellectual Property Office, the entire disclosure of which is incorporated herein by reference.

### BACKGROUND

### 1, Field

Aspects of embodiments of the present invention relate to a current collector for rechargeable lithium batteries and a rechargeable lithium battery including the same.

### 2. Description of the Related Art

In recent years, demand for high energy density and high capacity secondary batteries has grown rapidly with rapid spread of electronic devices using batteries, such as mobile phones, notebook computers, and electric vehicles. In particular, rechargeable lithium batteries have attracted attention as a power source for mobile devices due to light weight and high energy density thereof. Various research and development have been actively carried out to improve performance of rechargeable lithium batteries.

A rechargeable lithium battery includes a positive electrode and a negative electrode containing active materials allowing intercalation and deintercalation of lithium ions, and an electrolyte, and produces electricity through oxidation and reduction upon intercalation/deintercalation of the lithium ions at the positive electrode and the negative electrode.

A positive electrode material for rechargeable lithium batteries may include any of transition metal compounds, such as lithium cobalt oxide, lithium nickel oxide, lithium manganese oxide, and the like. A negative electrode material may include any of crystalline carbon materials, such as natural graphite or artificial graphite, or amorphous carbon materials.

### SUMMARY

According to an aspect of one or more embodiments of the present invention, a current collector for rechargeable lithium batteries with improved resistance, improved adhesion, and good flexibility is provided. According to another aspect of one or more embodiments of the present invention, a rechargeable lithium battery including the current collector is provided.

According to one or more embodiments of the present invention, a current collector for rechargeable lithium batteries includes: a polymer support layer; a conductive layer on at least one surface of the polymer support layer; and a carbon-containing layer on at least one surface of the polymer support layer, wherein the carbon-containing layer includes at least one of carbon nanotubes or carbon nanofibers extending from the polymer support layer or the conductive layer.

According to one or more embodiments of the present invention, a rechargeable lithium battery includes a negative electrode including the current collector for rechargeable lithium batteries; a positive electrode; and an electrolyte.

Embodiments of the present invention provide a current collector for rechargeable lithium batteries, which has good properties in terms of resistance, adhesion, and flexibility to be applied to rechargeable lithium batteries for flexible applications.

### BRIEF DESCRIPTION OF THE DRAWINGS

FIG. 1 is a cross-sectional view of a current collector for rechargeable lithium batteries according to an embodiment of the present invention.

FIG. 2 is a cross-sectional view of a current collector for rechargeable lithium batteries according to another embodiment of the present invention.

FIG. 3 is a cross-sectional view of a current collector for rechargeable lithium batteries according to another embodiment of the present invention.

FIG. 4 is a schematic diagram illustrating a method of forming a carbon-containing layer according to an embodiment of the present invention.

FIG. 5 is a schematic diagram illustrating a method of forming a carbon-containing layer according to another embodiment of the present invention.

FIG. 6 to FIG. 9 are schematic views of rechargeable lithium batteries according to some embodiments of the present invention.

FIG. 10 is a graph depicting an example of a stress-strain curve used to measure elongation and tensile strength.

### DETAILED DESCRIPTION

Herein, some example embodiments of the present invention will be described in further detail with reference to the accompanying drawings. However, it is to be understood that the following embodiments are provided by way of illustration, and the present invention is defined by the claims and equivalents thereto.

The terminology used herein is for the purpose of describing embodiments of the present invention and is not intended to be limiting of the present invention. Throughout the specification, unless specified otherwise, each element may be singular or plural.

Herein, “combinations thereof” may refer to mixtures, stacks, composites, copolymers, alloys, blends, and reaction products of components.

It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the drawings, thicknesses of various elements, layers, regions, and the like may be exaggerated for clarity of illustration, and the same elements may be denoted by like reference numerals throughout the specification. In addition, when an arbitrary element is referred to as being disposed (or located or positioned) “above” (or “below”) or “on” (or “under”) a component, it may mean that the arbitrary element is placed in contact with an upper (or lower) surface of the component and may also mean that another component may be interposed between the component and any arbitrary element disposed (or located or positioned) on (or under) the component.

Herein, “layer” includes not only a feature formed on an entire surface but also a feature formed on a surface in plane view.

Herein, “average particle diameter” may be measured by any method well known to those skilled in the art, for example, by a particle diameter analyzer, transmission electron micrographs, or scanning electron micrographs. Alternatively, the average particle diameter may be measured by counting the number of particles in each particle diameter range using a device employing a dynamic light-scattering method to analyze data, followed by calculating the average particle diameter based on the analyzed data. The average particle diameter may be measured from microscopic images or measured with a particle diameter analyzer and can be defined as the diameter of particles with a cumulative volume of 50 volume % in the particle diameter distribution.

Herein, “or” should not be construed as exclusive. For example, “A or B” is construed to include A, B, A+B, and the like.

Herein, “elongation” of a current collector may mean a percentage value calculated as strain of the current collector at fracture from a pre-test state in a tensile test. A higher percentage value indicates higher flexibility. Here, the elongation may refer to elongation at fracture, which is obtained from a stress-strain curve obtained by pulling a current collector specimen with constant force, with both sides of the specimen secured to a tensile tester. Specifically, for current collector specimens prepared in accordance with ASTM standard D412 (Type V specimen), strain in response to stress was measured at a rate of 5 mm/min under conditions of 25° C. and about 30% RH (relative humidity), and results were shown in a stress-strain curve. Strain at fracture of the current collector specimen may be obtained as elongation. FIG. 10 is a graph depicting an example of a stress-strain curve used to measure elongation and tensile strength.

Herein, “tensile strength” of a current collector is obtained from a value at which elongation of the current collector specimen cannot be measured due to fracture of the specimen and tensile strength of the specimen is maximized in the stress-strain curve obtained in measurement of elongation described above

### Current Collector for Rechargeable Lithium Batteries

A current collector for rechargeable lithium batteries according to an embodiment includes: a polymer support layer; and a conductive layer disposed on at least one surface of the polymer support layer, the current collector further including a carbon-containing layer disposed on at least one surface of the polymer support layer, wherein the carbon-containing layer includes at least one of carbon nanotubes or carbon nanofibers extending from the polymer support layer or the conductive layer.

As the current collector includes a laminate of the polymer support layer and the conductive layer as a matrix on which a carbon-containing layer is disposed, the current collector can improve safety of rechargeable lithium batteries by securing better penetration characteristics than a typical current collector formed of a metallic material and can also provide a price reduction effect through reduction in manufacturing costs of the rechargeable lithium batteries.

In an embodiment, the current collector may have an elongation of 10% to 100% and a tensile strength of 150 MPa to 400 MPa. Within these ranges, the current collector can have good flexibility to be used in rechargeable lithium batteries for foldable or flexible applications. For example, the current collector may have an elongation of 10, 15, 20, 25, 30, 35, 40, 45, 50, 55, 60, 65, 70, 75, 80, 85, 90, 95, or 100%, and, in an embodiment, 10% to 25% and a tensile strength of 150, 160, 170, 180, 190, 200, 210, 220, 230, 240, 250, 260, 270, 280, 290, 300, 310, 320, 330, 340, 350, 360, 370, 380, 390, or 400 MPa, and, in an embodiment, 200 MPa to 300 MPa. Herein, “flexibility” means that, even after bending the current collector to a cartain radius of curvature (e.g., a predetermined radius of curvature), there is no change in characteristics of a cell manufactured using the current collector, as compared to before bending.

According to an embodiment, the current collector concurrently (e.g., simultaneously) satisfying the elongation and the tensile strength within the above ranges can be realized by including the carbon-containing layer including at least one of carbon nanotubes or carbon nanofibers extending from the polymer support layer or the conductive layer, and adjusting a thickness ratio between the polymer support layer, the conductive layer, and the carbon-containing layer in the current collector.

The polymer support layer of the current collector may have a thickness that is less than the thickness of the carbon-containing layer and is greater than the thickness of the conductive layer. The polymer support layer may be more flexible than a typical metal current collector, thereby securing good flexibility. However, the conductive layer may be less flexible than the polymer support layer, thereby reducing elongation. The carbon-containing layer may extend from the polymer support layer or the conductive layer and may be thicker than the polymer support layer, whereby the current collector can achieve the elongation and the tensile strength within the above ranges.

In an embodiment, the thickness ratio between the polymer support layer, the conductive layer, and the carbon-containing layer ratio may be in a range from 3 to 8:1:10 to 20, for example, 3, 3.5, 4, 4.5, 5, 5.5, 6, 6.5, 7, 7.5, or 8:1:10, 10.5, 11, 11.5, 12, 12.5, 13, 13.5, 14, 14.5, 15, 15.5, 16, 16.5, 17, 17.5, 18, 18.5, 19, 19.5, or 20, and, in an embodiment, 4 to 7:1:10 to 20. Within these ranges, the current collector can achieve the aforementioned elongation and tensile strength.

In an embodiment, referring to FIG. 1, the current collector includes a polymer support layer 100; a conductive layer 110 disposed on an upper surface of the polymer support layer 100; and a carbon-containing layer 120 disposed on an upper surface of the conductive layer 110.

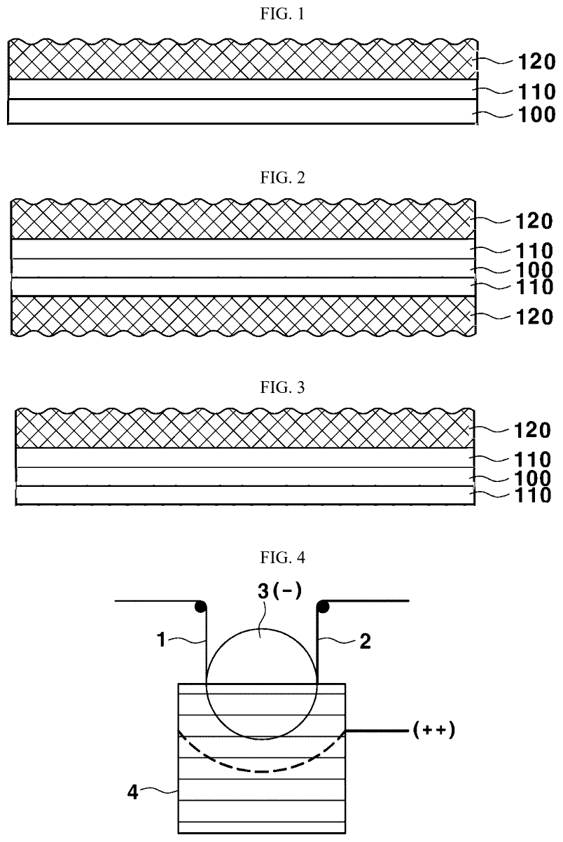

In another embodiment, referring to FIG. 2, the current collector includes a polymer support layer 100; conductive layers 110 disposed on upper and lower surfaces of the polymer support layer 100, respectively; and carbon-containing layers 120 disposed on opposite outermost surfaces of the conductive layers 110, respectively.

In another embodiment, referring to FIG. 3, the current collector includes a polymer support layer 100; conductive layers 110 disposed on upper and lower surfaces of the polymer support layer 100, respectively; and a carbon-containing layer 120 disposed on an uppermost surface of the conductive layer 110.

The current collector may be used as a current collector of a negative electrode or a positive electrode of a rechargeable lithium battery.

In an embodiment, the current collector may have a thickness of 10 μm to 100 μm, for example, 10, 15, 20, 25, 30, 35, 40, 45, 50, 55, 60, 65, 70, 75, 80, 85, 90, 95, or 100 μm, and, in an embodiment, 15 μm to 50 μm, and, in an embodiment, 15 μm to 30 μm. Within these ranges, the current collector can be suitably used as a current collector and can achieve the aforementioned elongation and tensile strength.

Next, the components of the current collector will be described in further detail.

### Polymer Support Layer

The polymer support layer includes one or more types of polymer materials. In some embodiments, the polymer material may include at least one selected from the group consisting of polyamides, polyimides, polyesters, polyolefins, polyacetylene hydrocarbons, siloxane polymers, polyethers, polyalcohols, polysulfones, polysaccharide polymers, amino acid polymers, sulfur nitride-based polymers, aromatic cyclic polymers, aromatic heterocyclic polymers, epoxy resins, phenol resins, derivatives thereof, crosslinked products thereof, copolymers thereof, and combinations thereof.

In an embodiment, the polymer material may include at least one selected from the group consisting of polycaprolactam (also known as Nylon 6), polyhexamethylene adipamide (also known as Nylon 66), polyparaphenylene terephthalamide (PPTA), polymethaphenylene isophthalamide (PMIA), polyethylene terephthalate (PET), polybutylene terephthalate (PBT), polyethylene naphthalate (PEN), polytrimethylene terephthalate, terephthalic acid-isophthalic acid-ethylene glycol terpolymer, polycarbonate (PC), polyethylene (PE), polypropylene (PP), ethylene-propylene rubber (PPE), polyvinyl alcohol (PVA), polystyrene (PS), polyvinyl chloride (PVC), polyvinylidene fluoride (PVDF), polytetrafluoroethylene (PTEE), polystyrene sulfonate sodium (PSS), polyacetylene, silicone rubber, polyoxymethylene (POM), polyphenylene ether (PPO), polyphenylene sulfide (PPS), polyethylene glycol (PEG), cellulose, starch, protein, polyphenyl, polypyrrole (PPy), polyaniline (PAN), polythiophene (PT), polypyridine (PPY), acrylonitrile-butadiene-styrene copolymer (ABS), derivatives thereof, crosslinked products thereof, copolymers thereof, and combinations thereof.

In some embodiments, the polymer support layer further includes an additive. The additive may include one or more types of metallic materials or inorganic non-metallic materials. The metallic material additives may include at least one selected from the group consisting of aluminum, aluminum alloys, copper, copper alloys, nickel, nickel alloys, titanium, titanium alloys, iron, iron alloys, silver, silver alloys, and combinations thereof. The inorganic non-metallic material additives may include at least one selected from the group consisting of carbon-based materials, aluminum oxide, silicon dioxide, silicon nitride, silicon carbide, boron nitride, silicates, titanium oxide, and combinations thereof, and may further include at least one selected from the group consisting of glass materials, ceramic materials, ceramic composite materials, and combinations thereof. The carbon-based material additive may include at least one selected from the group consisting of, for example, graphite, superconducting carbon, acetylene black, carbon black, Ketjen black, carbon dots, carbon nanotubes, graphene, carbon nanofibers, and combinations thereof.

In an embodiment, the polymer support layer may include at least one selected from the group consisting of polyethylene terephthalate (PET), polybutylene terephthalate (PBT), polyethylene naphthalate (PEN), polystyrene sulfonate (PSS), polyimide (PI), and combinations thereof. In an embodiment, the polymer support layer is a polyethylene terephthalate (PET) film.

In an embodiment, the polymer support layer may have a stack structure that is a combined structure of two or more layers, for example, two, three, four, or more layers.

In an embodiment, the polymer support layer may have a thickness of 5 μm to 50 μm, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm, and, in an embodiment, 5 μm to 30 μm, and, in an embodiment, 5 μm to 10 μm. Within these ranges, the current collector can be suitably used as a current collector and can achieve the aforementioned elongation and tensile strength.

### Conductive Layer

The conductive layer is a coating layer formed of a metal material, wherein the metal may include at least one of copper, zinc, nickel, chromium, aluminum, SUS, or alloys thereof.

The conductive layer may be formed by various plating methods, for example, electroless plating, electroplating, and the like, deposition, and the like.

In an embodiment, the conductive layer may have a thickness of 0.05 μm to 30 μm, for example, 0.05, 0.1, 0.15, 0.2, 0.25, 0.3, 0.35, 0.4, 0.45, 0.5, 1, 2, 3, 4, 5, 6, 7, 8, 9, 10, 20, or 30 μm, and, in an embodiment, 0.05 μm to 15 μm, and, in an embodiment, 0.5 μm to 5 μm. Within these ranges, the current collector can be suitably used as a current collector and can achieve the aforementioned elongation and tensile strength.

### Carbon-Containing Layer

The carbon-containing layer includes at least one of carbon nanotubes or carbon nanofibers extending from the polymer support layer or the conductive layer.

In the current collector according to an embodiment, the carbon-containing layer extends from the conductive layer, which is different from a typical coating layer formed by applying a composition including at least one of carbon nanotubes and carbon nanofibers to a polymer support layer or a conductive layer.

The carbon-containing layer may be formed by any typical methods known to those skilled in the art.

In an embodiment, referring to FIG. 4, a stack 1 of the polymer support layer and the conductive layer is moved through a roll to pass through an electroplating solution 4 that contains carbon nanotubes dispersed therein, for example, along a drum 3 at least partially immersed in the electroplating solution. As a result, the current collector 2 formed with a carbon-containing layer, which includes the carbon nanotubes extending on a surface of the conductive layer in the stack 1, can be manufactured.

The electroplating solutions typically contain a solution of a metal or metal ions and carbon nanotubes dispersed therein. The electroplating solution may also include a copper plating electrolyte based on copper sulfate acidified with sulfuric acid. In an embodiment, the bath may include a copper sulfate concentration of 0.1 moles to 1.0 moles and a sulfuric acid concentration of 0.2 moles to 4 moles. In an embodiment, the content of the carbon nanotubes in the bath may be in a range from 1 wt % to 50 wt %.

Example electroplating chemical bath:

CuSO₄ (0.1 M to 1 M)

H₂SO₄ (0.2 M to 2 M)
Multi-walled CNTs or carbon nanofibers (0.5 g/liter to 5 g/liter)
Surfactant (for example, Triton™) 0.1 vol % to 5 vol % solution
Stirred by magnetic stirrer at 60 rpm, solution at 25° C.
Electroplating current: 0.1 A/dm² to 8 A/dm² (Amps per square decimeter)

The drum serves as a negative electrode (−) and a positive electrode (++) formed of an attached metal (not shown) is used together with an electric field driving an attachment process. For example, an electric field is used to attract CNTs to a metal substrate such that CNTs can be at least partially enveloped by a metal composite during the electroplating process and extend from the attached metal composite layer.

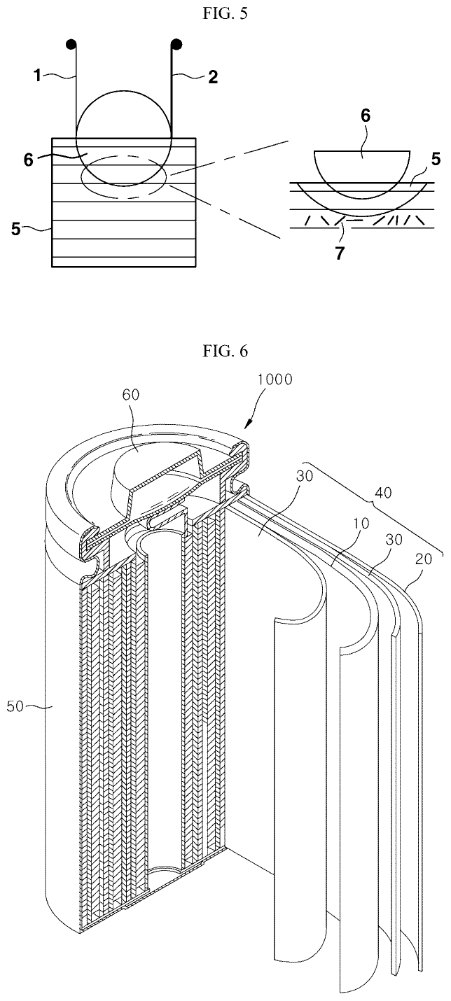

In an embodiment, referring to FIG. 5, the stack 1 of the polymer support layer and the conductive layer is moved through a roll and a magnetic field is used to align carbon nanotubes 7 in a solution 5 while potentially increasing the density of the carbon nanotubes formed on the conductive layer. For example, a magnet may be placed within the drum 6 to attract and align the carbon nanotubes in the solution such that the carbon nanotubes can be captured within and extend from a metal on a substrate as exemplified in a carbon nanotube metal composite, thereby preparing a current collector 2 including a carbon-containing layer that contains the carbon nanotubes extending on a surface of the conductive layer.

In an embodiment, the carbon nanotubes may include at least one of single-walled carbon nanotubes or multi-walled carbon nanotubes.

In an embodiment, the carbon-containing layer may have a thickness of 10 μm to 100 μm, for example, 10, 15, 20, 25, 30, 35, 40, 45, 50, 55, 60, 65, 70, 75, 80, 85, 90, 95, or 100 μm, and, in an embodiment, 10 μm to 50 μm, and, in an embodiment, 10 μm to 30 μm, and, in an embodiment, 10 μm to 20 μm. Within these ranges, the current collector can be suitably used as a current collector and can achieve the aforementioned elongation and tensile strength.

### Rechargeable Lithium Battery

A rechargeable lithium battery according to an embodiment includes a negative electrode; a positive electrode; and an electrolyte, wherein the negative electrode and/or the positive electrode includes the current collector for rechargeable lithium batteries according to one or more embodiments.

A rechargeable lithium battery according to an embodiment includes a negative electrode including the current collector for rechargeable lithium batteries according to one or more embodiments and an negative electrode material layer disposed on the current collector; a positive electrode; and an electrolyte.

### Negative Electrode

The negative electrode includes the current collector for rechargeable lithium batteries according to one or more embodiments of the invention and a negative electrode material layer disposed on the current collector. The negative electrode material layer includes a negative electrode material and may further include a binder and/or a conductive material.

In an embodiment, for example, the negative electrode material layer may include 90 wt % to 99 wt % of the negative electrode material, 0.5 wt % to 5 wt % of the binder, and 0 wt % to 5 wt % of the conductive material.

The negative electrode material includes a material allowing reversible intercalation/deintercalation of lithium ions, lithium metal, a lithium metal alloy, a material capable of being doped to lithium and de-doped therefrom, or a transition metal oxide.

The material allowing reversible intercalation/deintercalation of lithium ions may include a carbon-based negative electrode material, for example, crystalline carbon, amorphous carbon, or a combination thereof. The crystalline carbon may include, for example, graphite, such as natural graphite or artificial graphite, in amorphous, plate, flake, spherical, or fibrous form, and the amorphous carbon may include, for example, soft carbon, hard carbon, mesoporous pitch carbides, calcined coke, and the like.

As the lithium metal alloy, an alloy of lithium and a metal selected from among Na, K, Rb, Cs, Fr, Be, Mg, Ca, Sr, Si, Sb, Pb, In, Zn, Ba, Ra, Ge, Al and Sn may be used.

The material capable of being doped to lithium and de-doped therefrom may be an Si-based negative electrode material or an Sn-based negative electrode material. The Si-based negative electrode material may be silicon, a silicon-carbon composite, SiOₓ (0<x<2), Si-Q alloys (where Q is selected from among alkali metals, alkali-earth metals, Group XIII elements, Group XIV elements (excluding Si), Group XV elements, Group XVI elements, transition metals, rare-earth elements, and combinations thereof), or combinations thereof. The Sn-based negative electrode material may be Sn, SnO₂, an Sn alloy, or a combination thereof.

The silicon-carbon composite may be a composite of silicon and amorphous carbon. According to an embodiment, the silicon-carbon composite may be prepared in the form of silicon particles having an amorphous carbon coating formed on a surface thereof. For example, the silicon-carbon composite may include secondary particles (cores) composed of primary silicon particles and an amorphous carbon coating layer (shell) formed on the surface of the secondary particle. The amorphous carbon may also be placed between the primary silicon particles such that, for example, the primary silicon particles are coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer disposed on the core.

The Si-based negative electrode material or the Sn-based negative electrode material may be used in combination with the carbon-based negative electrode material.

The binder functions to attach the negative electrode material particles to each other while attaching the negative electrode material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymers, polystyrene, polyurethane, polytetrafluoroethylene, polyvinylidene fluoride, polyethylene, polypropylene, polyamideimide, polyimide, or combinations thereof.

The aqueous binder may be selected from the group consisting of styrene-butadiene rubbers, (meth)acrylated styrene-butadiene rubbers, (meth)acrylonitrile-butadiene rubbers, (meth)acrylic rubbers, butyl rubbers, fluorinated rubbers, polyethylene oxide, polyvinyl pyrrolidone, polyepichlorohydrin, polyphosphazene, poly(meth)acrylonitrile, ethylene propylene diene copolymers, polyvinyl pyridine, chlorosulfonated polyethylene, latex, polyester resins, (meth)acryl resins, phenol resins, epoxy resins, polyvinyl alcohol, and combinations thereof.

If the aqueous binder is used as the negative electrode binder, a cellulose-based compound capable of imparting viscosity may be further included. The cellulose-based compound may be a mixture of carboxymethylcellulose, hydroxypropyl methylcellulose, methylcellulose, or alkali metal salts thereof. In an embodiment, the alkali metal may be Na, K, or Li.

The dry binder may be a fibrous polymeric material and may include, for example, polytetrafluoroethylene, polyvinylidene fluoride, a polyvinylidene fluoride-hexafluoropropylene copolymer, polyethylene oxide, or a combination thereof.

The conductive material imparts conductivity to the electrodes and may be any electrically conductive material that does not cause chemical change in cells under construction. In an embodiment, the conductive material may include, for example, any of carbon materials, such as natural graphite, artificial graphite, carbon black, acetylene black, Ketjen black, carbon fibers, carbon nanofibers, carbon nanotubes, and the like; metal-based materials in the form of metal powders or metal fibers containing copper, nickel, aluminum, silver, and the like; conductive polymers, such as polyphenylene derivatives and the like; or mixtures thereof.

### Positive Electrode

The positive electrode for rechargeable lithium batteries may include a current collector and a positive electrode material layer disposed on the current collector. The positive electrode material layer may include a positive electrode material and may further include a binder and/or a conductive material.

In an embodiment, the positive electrode may further include an additive capable of acting as a sacrificial positive electrode.

In an embodiment, the positive electrode material may be present in an amount of 90 wt % to 99.5 wt % based on 100 wt % of the positive electrode material layer, and each of the binder and the conductive material may be present in an amount of 0.5 wt % to 5 wt % based on 100 wt % of the positive electrode material layer.

As the positive electrode material, a compound allowing reversible intercalation and deintercalation of lithium (lithiated intercalation compound) may be used. In an embodiment, the positive electrode material may be at least one complex oxide of a metal selected from among cobalt, manganese, nickel, and combinations thereof with lithium.

The composite oxide may be a lithium transition metal composite oxide. In an embodiment, the composite oxide may be a lithium nickel oxide, a lithium cobalt oxide, a lithium manganese oxide, a lithium iron phosphate compound, a cobalt-free lithium manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂ (PO₄)₃ (0≤f≤2); and LiₐFePO₄ (0.90≤a≤1.8).

In the above formulas, A is Ni, Co, Mn, or a combination thereof; X denotes Al, Ni, Co, Mn, Cr, Fe, Mg, Sr, V, a rare-earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

In an embodiment, the positive electrode material may be a high nickel-content positive electrode material containing 80 mol % or more, 85 mol % or more, 90 mol % or more, 91 mol % or more, or 94 mol % to 99 mol % of nickel based on 100 mol % of metals excluding lithium in the lithium transition metal composite oxide. The high nickel-content positive electrode material can realize high capacity and thus can be applied to high capacity/high density rechargeable lithium batteries.

The binder functions to attach positive electrode material particles to each other while attaching the positive electrode material to the current collector. The binder may include, for example, any of polyvinyl alcohol, carboxymethylcellulose, hydroxypropylcellulose, diacetylcellulose, polyvinyl chloride, carboxylated polyvinyl chloride, polyvinyl fluoride, polymers including ethylene oxide, polyvinyl pyrrolidone, polyurethane, polytetrafluoroethylene, polyvinylidene fluoride, polyethylene, polypropylene, styrene-butadiene rubbers, (meth)acrylated styrene-butadiene rubbers, epoxy resins, (meth)acrylic resins, polyester resins, Nylon, and the like, without being limited thereto.

The conductive material imparts conductivity to the electrodes and may be any electrically conductive material that does not cause chemical change in cells under construction. The conductive material may include, for example, carbon materials, such as natural graphite, artificial graphite, carbon black, acetylene black, Ketjen black, carbon fibers, carbon nanofibers, carbon nanotubes, and the like; metal-based materials in the form of metal powders or metal fibers containing copper, nickel, aluminum, silver, and the like; conductive polymers, such as polyphenylene derivatives and the like; and mixtures thereof.

In an embodiment, the current collector may include Al and the like, without being limited thereto.

### Electrolyte

The electrolyte includes a non-aqueous organic solvent and a lithium salt.

The non-aqueous organic solvent acts as a medium through which ions involved in electrochemical reaction of a cell can move.

The non-aqueous organic solvent may be a carbonate-based solvent, an ester-based solvent, an ether-based solvent, a ketone-based solvent, an alcohol-based solvent, a non-amphoteric solvent, or a combination thereof.

The carbonate-based solvents may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

The ester-based solvents may include methyl acetate, ethyl acetate, n-propyl acetate, dimethyl acetate, methyl propionate, ethyl propionate, decanolide, mevalonolactone, valerolactone, caprolactone, and the like.

The ether-based solvents may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvents may include ethyl alcohol, isopropyl alcohol, and the like, and the non-amphoteric solvent may include nitriles, such as R—CN (where R is a straight, branched or cyclic hydrocarbon group having 2 to 20 carbon atoms and may include double bonds, aromatic rings, or ether groups); amides, such as dimethylformamide; dioxolanes, such as 1,3-dioxolane, 1,4-dioxolane, and the like; sulfolanes; and the like.

The non-aqueous organic solvent may be used alone or as a mixture thereof.

In use of the carbonate-based solvent, a mixture of a cyclic carbonate and a chained carbonate may be used, and the cyclic carbonate and the chained carbonate may be mixed in a volume ratio of 1:1 to 1:9.

The lithium salt is a substance that is soluble in an organic solvent and functions as a source of lithium ions in a battery, enabling operation of a basic rechargeable lithium battery while facilitating transfer of the lithium ions between the positive electrode and the negative electrode. The lithium salt may include at least one selected from among LiPF₆, LiBF₄, LiSbF₆, LiAsF₆, LiClO₄, LiAlO₂, LiAlCl₄, LIPO₂F₂, LiCl, LiI, LIN (SO₃C₂F₅)₂, Li(FSO₂)₂N (lithium bis(fluorosulfonyl)imide (LiFSI)), LiC₄F₉SO₃, LIN (CₓF₂ₓ₊₁SO₂) (C_{y}F_{2y+1}SO₂) (where x and y are integers of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### Separator

Depending on the type of rechargeable lithium battery, the separator may be interposed between the positive electrode and the negative electrode. For such a separator, polyethylene, polypropylene, polyvinylidene fluoride, or at least two layers thereof may be used, as well as mixed layers, such as a polyethylene/polypropylene bilayer separator, a polyethylene/polypropylene/polyethylene trilayer separator, a polyethylene/polyethylene/polypropylene trilayer separator, and the like.

The separator may include a porous substrate and a coating layer that includes an organic material, an inorganic material, or a combination thereof on one or both surfaces of the porous substrate.

The porous substrate may be a polymer layer formed of a polymer selected from among polyolefins, such as polyethylene polypropylene, and the like, polyesters, such as polyethylene terephthalate, polybutylene terephthalate, and the like, polyacetal, polyamides, polyimides, polycarbonates, polyether ketones, polyarylether ketones, polyetherimides, polyamideimides, polybenzimidazole, polyethersulfone, polyphenylene oxides, cyclic olefin copolymers, polyphenylene sulfides, polyethylene naphthalate, glass fiber, Teflon, and polytetrafluoroethylene, copolymers thereof, or mixtures thereof.

In an embodiment, the organic material may include a polyvinylidene fluoride polymer or a (meth)acrylic polymer.

In an embodiment, the inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH)₂, boehmite, and combinations thereof, without being limited thereto.

The organic material and the inorganic material may be present in a mixed state in one coating layer or may be present in the form of a stack structure of a coating layer including the organic material and a coating layer including the inorganic material.

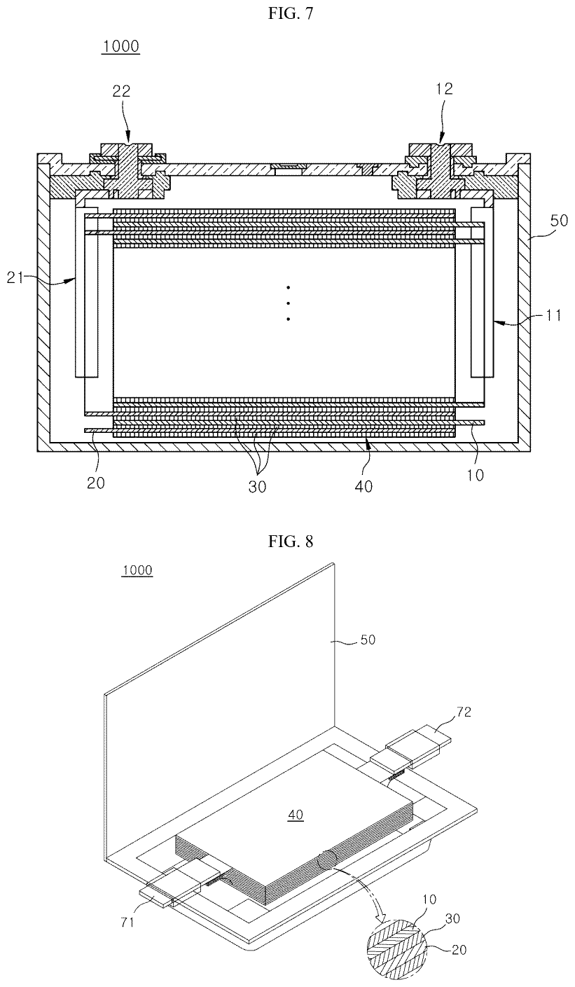

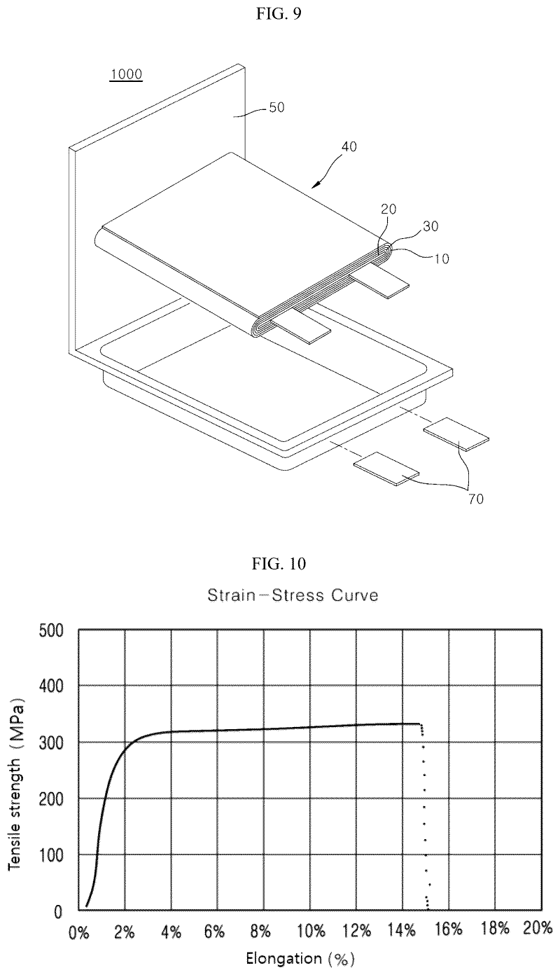

Rechargeable lithium batteries may be any of a cylindrical rechargeable battery, a prismatic rechargeable battery, a pouch-type rechargeable battery, a coin-type rechargeable battery, and the like, based on a shape thereof. FIG. 6 to FIG. 9 are schematic views of rechargeable lithium batteries according to some embodiments of the present invention, in which FIG. 6 shows a cylindrical rechargeable battery, FIG. 7 shows a prismatic rechargeable battery, and FIG. 8 and FIG. 9 show pouch-type rechargeable batteries. Referring to FIG. 6 to FIG. 9, a rechargeable lithium battery 1000 may include an electrode assembly 40 in which a separator 30 is interposed between a positive electrode 10 and a negative electrode 20, and a case 50 that receives the electrode assembly 40 therein. The positive electrode 10, the negative electrode 20, and the separator 30 may be embedded in an electrolyte (not shown). The rechargeable lithium battery 1000 may include a sealing member 60 that seals the case 50, as shown in FIG. 6. In an embodiment, as shown in FIG. 7, the rechargeable lithium battery 1000 may include a positive electrode lead tab 11, a positive electrode terminal 12, a negative electrode lead tab 21, and a negative electrode terminal 22. Referring to FIG. 8 and FIG. 9, in an embodiment, the rechargeable lithium battery 1000 may include electrode tabs 70, that is, a positive electrode tab 71 and a negative electrode tab 72, which function as electrical pathways conducting current generated in the electrode assembly 40 to the outside.

Rechargeable lithium batteries according to embodiments of the present invention may be applied to automobiles, mobile phones, and/or various other electrical devices, without being limited thereto.

Next, the present invention will be described in further detail with reference to some examples. However, it is to be understood that these examples are provided for illustration and are not to be construed in any way as limiting the invention.

### Example 1

### Preparation of Current Collector

A copper-based conductive layer (thickness: 1 μm) was formed by cleaning both surfaces of a polyethylene terephthalate film (thickness: 6 μm), followed by depositing an evaporated metal on both, or opposite, surfaces of the polyethylene terephthalate film through a cooling system in a vacuum plating chamber, in which the evaporated metal was prepared by melting and evaporating a high purity copper wire in a metal evaporation chamber at a high temperature of 1,300° C. to 2,000° C.

Thereafter, a carbon nanotube layer (thickness: 10 μm) was formed on a surface of the copper-based conductive layer by growing carbon nanotubes on the copper-based conductive layer according to the method described above with reference to FIG. 4.

### Preparation of Negative Electrode

A negative electrode material slurry was prepared by mixing 97.5 wt % of artificial graphite, 1.0 wt % of carboxymethylcellulose, and 1.5 wt % of styrene butadiene rubber (SBR) in water as a solvent. A negative electrode including a negative electrode material layer on a surface of the current collector was prepared by applying the prepared negative electrode material slurry to a surface of the prepared current collector, followed by drying and rolling.

### Preparation of Positive Electrode

A positive electrode material slurry was prepared by mixing 96 wt % of LiCoO₂, 2 wt % of Ketjen black and 2 wt % of polyvinylidene fluoride in N-methylpyrrolidone as a solvent. A positive electrode including a positive electrode material layer disposed on the current collector was prepared by applying the prepared positive electrode material slurry to an aluminum current collector, followed by drying and rolling.

### Preparation of Cell

A lithium secondary cell was prepared by disposing a separator between the negative electrode and the positive electrode and using an electrolyte. The electrolyte was a mixed solvent of ethylene carbonate and ethylmethyl carbonate (volume ratio: 50:50) in which LiPF₆ was dissolved.

### Example 2

A current collector and a cell were prepared in the same manner as in Example 1 except that the thickness of the carbon nanotube-containing layer was changed to 20 μm.

### Comparative Example 1

A cell was prepared in the same manner as in Example 1 except that copper foil (thickness: 8 μm) was used alone as a current collector for negative electrodes.

### Comparative Example 2

A current collector for negative electrodes (without the polymer support layer of Example 1) was prepared by growing carbon nanotubes on copper foil (thickness: 8 μm) to form a carbon nanotube layer (thickness: 10 μm) on both, or opposite, surfaces of the copper foil according to the method described with reference to FIG. 4.

A cell was prepared in the same manner as in Example 1 using the current collector for negative electrodes.

### Comparative Example 3

A current collector and a cell were prepared in the same manner as in Example 1 except that a carbon nanotube layer (thickness: 10 μm) was formed on a surface of the copper-based conductive layer by coating a carbon nanotube composition after the copper-based conductive layer was formed in Example 1.

### Evaluation Example 1: Conduction Resistance (Specific Resistance) (Unit: mΩm)

The negative electrodes prepared in the Examples and Comparative Examples were cut into specimens having a certain size (32 φ). Resistance of each of the negative electrode specimens was measured using an Agilent Technologies model 4294A LCR meter and was converted into specific resistance.

### Evaluation Example 2: Adhesive Strength (Unit: Gf/Mm)

For each of the negative electrodes prepared in the Examples and Comparative Examples, adhesive strength between the current collector and the negative electrode material layer was measured using a UTM tensile tester. A sample was prepared by attaching a slide glass to a side of a double-sided tape and the negative electrode to the other side of the double-sided tape. The negative electrode material layer of the negative electrode was bonded to the other side of the double-sided tape. Here, the double-sided tape, the slide glass, and the negative electrode had the same size and a rectangular shape having a size of 10 cm×5 cm (length×width). With the sample mounted on a UTM tensile strength tester, adhesive strength was measured by peeling off the negative electrode from the slide glass under conditions of a peeling angle of 180 degrees and a peeling rate of 100 mm/minute at a peeling temperature of 25° C.

### Evaluation Example 3: Tensile Strength (unit: MPa)

Tensile strength of each of the negative electrode current collectors prepared in the Examples and Comparative Examples was measured using a DMA800 (TA Instruments), and specimens were prepared in accordance with ASTM standard D412 (Type V specimens).

For each of the specimens, strain in response to stress was measured at a rate of 5 mm/minute under conditions of 25° C. and about 30% RH (relative humidity), and tensile strength at fracture was obtained from a stress-strain curve.

### Evaluation Example 4: Elongation (Unit: %)

Evaluation was carried out in the same manner as in Evaluation Example 3 and strain at fracture was obtained as elongation.

### Evaluation Example 5: Penetration Characteristics

A lithium secondary cell was fully charged to 4.25 V at a constant current of 0.5 C at 25° C., followed by 0.02 C cut-off while maintaining 4.25 V in constant voltage mode. Then, the secondary cell was penetrated with a 3-φ nail at 150 mm/second. Each of the cells prepared in the Examples and Comparative Examples was evaluated using a total of five samples. No penetration of all five samples was rated as ⊚; penetration of one or two samples was rated as ◯; penetration of three or four samples was rated as Δ; and penetration of all five samples was rated as X. The cells rated as ⊚ and ∘ can be used in practice.

### Evaluation Example 6: Flexural Property

After bending each of the cells employing the current collectors prepared in the Examples and Comparative Examples to a radius of curvature of 3 mm, capacity of the cell was evaluated compared to before bending. No change in capacity was rated as ∘ and change in capacity was rated as X.

TABLE 1

| | | | | Comparative | Comparative | Comparative |
|---|---|---|---|---|---|---|
| | | Example | Example | Example | Example | Example |
| | | 1 | 2 | 1 | 2 | 3 |
| Thickness | Polymer | 6 | 6 | — | — | 6 |
| (μm) | support | | | | | |
| | layer | | | | | |
| | Conductive | 1 | 1 | — | — | 1 |
| | layer | | | | | |
| | Carbon | 10 | 20 | — | 10 | 10 |
| | nanotube- | | | | | |
| | containing | | | | | |
| | layer | | | | | |
| | Copper | — | — | 8 | 8 | — |
| | foil | | | | | |

| | | | | | |
|---|---|---|---|---|---|
| Specific resistance | 603 | 340 | 416 | 73 | 812 |
| Adhesive strength | 0.82 | 0.76 | 0.94 | 0.83 | 0.81 |
| Tensile strength | 211 | 215 | 332.7 | 223 | 217 |
| Elongation | 20.2 | 13.1 | 7.6 | 4.5 | 15.2 |
| Penetration | ◯ | ◯ | X | X | ◯ |
| characteristics | | | | | |
| Flexural property | ◯ | ◯ | X | X | X |

As shown in Table 1, it could be seen that the negative electrodes and the cells prepared using the current collectors of the Examples exhibited improved properties in terms of resistance, adhesive strength, and penetration characteristics. In addition, as shown in Table 1, the current collectors of the Examples satisfied requirements for tensile strength and elongation. Therefore, although not shown in Table 1, it is expected that the current collectors of the Examples have excellent flexibility.

Although the present invention has been described with reference to some example embodiments and drawings, it is to be understood that the present invention is not limited thereto, and various modifications, changes, alterations, and equivalent embodiments can be made by those skilled in the art without departing from the spirit and scope of the present invention.

What is claimed is:

1. A current collector for rechargeable lithium batteries, comprising:
a polymer support layer;
a conductive layer on at least one surface of the polymer support layer; and
a carbon-containing layer on at least one surface of the polymer support layer,
wherein the carbon-containing layer comprises at least one of carbon nanotubes or carbon nanofibers extending from the polymer support layer or the conductive layer.

2. The current collector as claimed in claim 1, wherein the current collector has an elongation of 10% to 100% and a tensile strength of 150 MPa to 400 MPa.

3. The current collector as claimed in claim 1, wherein the polymer support layer has a thickness less than a thickness of the carbon-containing layer and greater than a thickness of the conductive layer.

4. The current collector as claimed in claim 1, wherein a thickness ratio between the polymer support layer, the conductive layer, and the carbon-containing layer is from 3 to 8:1:10 to 20.

5. The current collector as claimed in claim 4, wherein the polymer support layer has a thickness of 10 μm to 100 μm, the conductive layer has a thickness of 0.05 μm to 30 μm, and the carbon-containing layer has a thickness of 10 μm to 100 μm.

6. The current collector as claimed in claim 1, wherein the conductive layer and the carbon-containing layer are sequentially arranged on an upper surface of the polymer support layer.

7. The current collector as claimed in claim 1, wherein the conductive layer and the carbon-containing layer are sequentially arranged on each of an upper surface and a lower surface of the polymer support layer.

8. The current collector as claimed in claim 1, wherein the conductive layer and the carbon-containing layer are sequentially arranged on an upper surface of the polymer support layer, and the conductive layer is further arranged on a lower surface of the polymer support layer.

9. The current collector as claimed in claim 1, wherein a polymer of the polymer support layer comprises at least one selected from the group consisting of polyamides, polyimides, polyesters, polyolefins, polyacetylene hydrocarbons, siloxane polymers, polyethers, polyalcohols, polysulfones, polysaccharide polymers, amino acid-based polymers, sulfur nitride-based polymers, aromatic cyclic polymers, aromatic heterocyclic polymers, epoxy resins, phenol resins, derivatives thereof, crosslinked products thereof, copolymers thereof, and combinations thereof.

10. The current collector as claimed in claim 1, wherein the conductive layer comprises at least one of copper, zinc, nickel, chromium, aluminum, SUS, or alloys thereof.

11. A rechargeable lithium battery comprising: a negative electrode comprising the current collector for rechargeable lithium batteries as claimed in claim 1; a positive electrode; and an electrolyte.

12. A rechargeable lithium battery comprising: a positive electrode comprising the current collector for rechargeable lithium batteries as claimed in claim 1; a negative electrode; and an electrolyte.
